(19) United States
(12) Patent Application Publication
(10) Pub. No.: US 2009/0086599 A1
(43) Pub. Date: Apr. 2, 2009

(54) OPTICAL DISC APPARATUS AND TRACKING CONTROL METHOD

(75) Inventor: Yoshinori Tazaki, Yokohama-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 12/238,037

(22) Filed: Sep. 25, 2008

(30) Foreign Application Priority Data
Sep. 28, 2007 (JP) 2007-256517

(51) Int. Cl. G11B 20/18

(52) U.S. Cl. 369/53.17

(57) ABSTRACT

According to one embodiment, an optical disc apparatus includes a pickup which receives reflected light from an optical disc, a tracking error detecting section which detects a tracking error from an output signal of the pickup, a reproducing section which reproduces data in a phase lock state of a data phase, the data lock state being detected by a phase lock loop based on the output signal of the pickup, and a control section which renders a tracking servo of the pickup for the optical disc valid when a residual component of an error detection signal from the tracking error detecting section in a tracking servo-on state falls within a predetermined allowable range, and renders the tracking servo of the pickup invalid with release of the phase lock state.

### CROSS-REFERENCE TO RELATED APPLICATIONS

This application is based upon and claims the benefit of priority from Japanese Patent Application No. 2007-256517, filed Sep. 28, 2007, the entire contents of which are incorporated herein by reference.

### BACKGROUND

1. Field

One embodiment of the present invention relates to an optical disc apparatus and a tracking control method, which perform tracking control to irradiate an optical disc with a laser beam.

2. Description of the Related Art

In the prior art, determination of success or failure of track catch is mainly performed by a residual detecting method of a tracking error signal or a cross frequency counting method of a tracking error signal. In the residual method, a tracking error signal is monitored after tracking servo-on (for example, refer to Jpn. Pat. Appln. KOKAI Pub. No. 2004-55054). When the tracking error signal falls within a window range ZO illustrated in FIG. 5 for a predetermined period, it is determined that track catch has succeeded. FIG. 5 illustrates an example in which track catch has succeeded. In comparison with this, when the tracking error signal TE is frequently out of the window range ZO as illustrated in FIG. 6, it is determined that track catch has failed, and a tracking servo signal TRKDRV is turned off to prevent a malfunction.

In recent years, optical discs of high data density, such as Blu-ray discs (BD), have come on the market, and noise components of a tracking error signal TE increase in accordance with the data density. Further, since multi-layering of discs into three layers or more has been achieved at an increasingly fast rate, such noise components have been further increased. In addition, high-density double-sided discs such as combo-format discs have been standardized, and it is required to take measures against such noise components.

In the meantime, when determination of track catch for optical discs having high data density is performed on the basis of a TE signal as in the prior art, there is the possibility that the tracking servo signal TRKDRV is turned off due to the influence of noise components, even when track catch has succeeded as illustrated in FIG. 7. However, if the tracking servo is actually off, it is necessary to repeatedly change parameters in a loop, as illustrated by arrows in FIG. 8 to read data. When the loop is performed, an electric current continuously flows through the track actuator of the processing unit. The various parameters include RF equalizer set values for data reading and other parameters, as well as servo parameters such as focus balance, focus offset, tracking balance, tracking offset, liquid crystal set values, and tilt servo set values. Therefore, in a system in which parameters are changed after determining that data cannot be read and then the tracking servo signal is turned off, not only a heavy load is put on the track actuator of the processing unit, but also electric current is wasted.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary diagram illustrating a configuration of an optical disc apparatus according to an embodiment of the present invention.

FIG. 2 is an exemplary waveform diagram illustrating a signal waveform obtained when track catch has succeeded in the optical disc apparatus of FIG. 1.

FIG. 3 is an exemplary waveform diagram illustrating a signal waveform obtained when track catch has failed in the optical disc apparatus of FIG. 1.

FIG. 4 is an exemplary flowchart illustrating a tracking control operation performed in the optical disc apparatus of FIG. 1.

FIG. 5 is a waveform diagram illustrating a signal waveform obtained when track catch has succeeded in the prior art.

FIG. 6 is a waveform diagram illustrating a signal waveform obtained when track catch has failed in the prior art.

FIG. 7 is a waveform diagram illustrating a problem that tracking servo is turned off due to noise in the prior art.

FIG. 8 is a flowchart illustrating conventional tracking control operation.

### DETAILED DESCRIPTION

Various embodiments according to the invention will be described hereinafter with reference to the accompanying drawings.

According to an embodiment of the present invention, there is provided an optical disc apparatus comprising: a pickup which receives reflected light from an optical disc; a tracking error detecting section which detects a tracking error from an output signal of the pickup; a reproducing section which reproduces data in a phase lock state of a data phase, the data lock state being detected by a phase lock loop based on the output signal of the pickup; and a control section which renders a tracking servo of the pickup for the optical disc valid when a residual component of an error detection signal from the tracking error detecting section in a tracking servo-on state falls within a predetermined allowable range, and renders the tracking servo of the pickup invalid with release of the phase lock state.

According to an embodiment of the present invention, there is provided a tracking control method comprising: receiving reflected light from an optical disc by a pickup; detecting a tracking error as a tracking error signal from an output signal of the pickup; and reproducing data in a phase lock state of a data phase, the data lock state being detected by a phase lock loop based on the output signal of the pickup, wherein a tracking servo of the pickup for the optical disc is rendered valid when a residual component of the tracking error signal in a tracking servo-on state falls within a predetermined allowable range, and the tracking servo of the pickup is rendered invalid with release of the phase lock state.

According to the optical disc apparatus and the tracking control method, a tracking servo of a pickup for an optical disc is made valid when a residual component of a tracking error signal in a tracking servo-on state falls within a predetermined allowable range, and is made invalid with release of a phase lock state of a data phase, which is detected by a phase lock loop from an output signal of the pickup. In this case, even when the residual component of the tracking error signal in the tracking servo-on state comes to easily exceed the predetermined allowable range due to noise components that result from the increasing data densities of optical discs, the tracking servo of the pickup is not made invalid as long as the phase lock state of the data phase is continued. Therefore, it is possible to reduce the influence of noise components on the tracking error signal in determination of track catch. Specifically, it is possible to prevent malfunction of the tracking servo, and resolve delays in issue of commands and access operation.

An optical disc apparatus according to an embodiment of the present invention will now be described below.

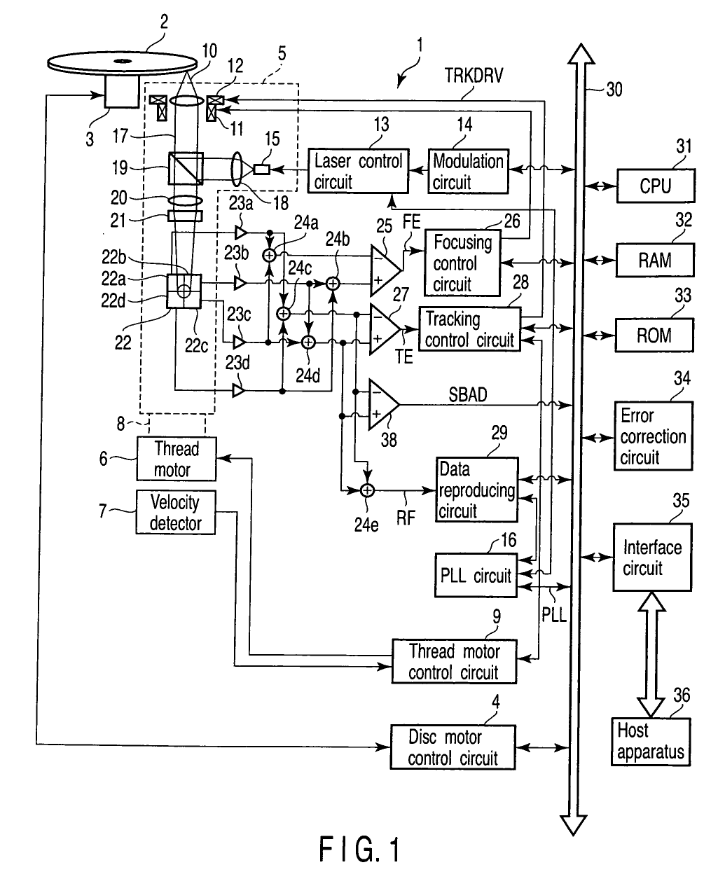

FIG. 1 illustrates a configuration of the optical disc apparatus 1. An optical disc 2 is an optical disc on which user data can be recorded, or a read-only optical disc. The optical disc 2 has spiral land tracks and group tracks which are formed on a surface thereof, and is driven by a disc motor 3. The disc motor 3 is controlled by a disc motor control circuit 4. An optical pickup 5 performs recording and reproducing of information for the optical disc 2. The optical pickup 5 is connected to a thread motor 6 through a connecting section 8 including a gear and the like, and is movable in a radial direction of the optical disc 2 by the driving force of the thread motor 6. The thread motor 6 is controlled by a thread motor control circuit 9. The thread motor control circuit 9 is connected to a velocity detector 7 which detects the velocity of the optical pickup 5. The thread motor control circuit 9 drives the thread motor 6 on the basis of a velocity signal being a detection result from the velocity detector 7 to move the optical pickup 5. The optical pickup 5 has an objective lens 10 which is movably supported by a wire or a leaf spring (not shown). The objective lens 10 is movable in a focusing direction (the optical axis direction of the lens) by driving of a focus direction drive coil 11, and movable in a tracking direction (a direction orthogonal to the optical axis of the lens) by driving of a track direction drive coil 12.

A modulation circuit 14 performs, for example, 8-14 modulation (EFM), which is for DVD recording media, for data supplied from a host apparatus 36 through an interface circuit 35 in information recording (mark formation), and supplies EFM data obtained by the modulation to a laser control circuit 13. The laser control circuit 13 supplies a write signal based on the EFM data to a laser diode 15. The laser diode 15 generates laser light in accordance with the write signal. The laser light is applied onto the optical disc 2 through a collimating lens 18, a half prism 19, and the objective lens 10.

Reflected light from the optical disc 2 is guided to an optical detector 22 through the objective lens 10, the half prism 19, a collective lens 20, and a cylindrical lens 21. The optical detector 22 is formed of four split light receiving portions 22a to 22d. Output signals from the light receiving portions 22a to 22d are supplied to a first differential amplifier 25 and a second differential amplifier 27, through current-voltage (I-V) converting amplifiers 23a to 23d and adders 24a to 24d, respectively. The first differential amplifier 25 outputs a focus error signal FE generated in accordance with a difference between the output signals of the adders 24a and 24b. A focusing control circuit 26 outputs a focus control output signal based on the focus error signal FE output from the first differential amplifier 25. The focus direction drive coil 11 drives the objective lens 10 in accordance with the output signal from the focusing control circuit 26, and thereby always sets the just-focus position of the laser light at an information recording surface of the optical disc 2. The second differential amplifier 27 outputs a tracking error signal TE generated in accordance with a difference between the output signals of the adders 24c and 24d. The amplifiers 23a to 23d, the adders 24a to 24d, and the differential amplifier 27 form a tracking error detector. A tracking control circuit 28 outputs a tracking servo signal TRKDRV based on the tracking error signal TE output from the second differential amplifier 27. The track direction drive coil 12 drives the objective lens 10 in accordance with the output signal from the tracking control circuit 28, and sets the center position of the objective lens 10 on a track on the optical disc 2. The tracking error signal TE is also supplied to the thread motor control circuit 9, as well as the tracking control circuit 28. The thread motor control circuit 9 drives the thread motor 6 based on the tracking error signal TE, and moves the optical pickup 5 in the radial direction of the optical disc 2, such that the objective lens 10 is positioned in the vicinity of the center position in the optical pickup 5.

An adder 24e outputs a sum signal of the output signals of the light-receiving portions 22a to 22d which form the optical detector 22, that is, a result of addition of the output signals of the adders 24c and 24d, to a data reproducing circuit 29 as a reproduction signal RF. The reproduction signal RF reflects change in reflectance from a pit (recorded data) recorded on the optical disc 2. The data reproducing circuit 29 reproduces recorded data on the basis of a reproduction clock signal from a PLL circuit 16. The PLL circuit 16 detects a data phase from the reproduction signal RF, and obtains a reproduction clock signal by rendering the data phase in a phase lock state. The reproduction data reproduced by the data reproducing circuit 29 is subjected to error correction by an error correction circuit 34 by using an error correction code assigned to the data, and then output to the host apparatus 36 through the interface circuit 35.

The disc motor control circuit 4, the thread motor control circuit 9, the laser control circuit 13, the modulation circuit 14, the PLL circuit 16, the data reproducing circuit 29, the focusing control circuit 26, and the tracking control circuit 28 can be formed in one LSI chip serving as a servo control circuit, and these circuits are controlled by a CPU 31 through a bus 30. The CPU 31 performs comprehensive control of the optical disc apparatus 1, in accordance with operation commands supplied from the host apparatus 36 through the interface circuit 35. In addition, the CPU 31 uses a RAM 32 as a work area, and performs control operation in accordance with a control program recorded on a ROM 33.

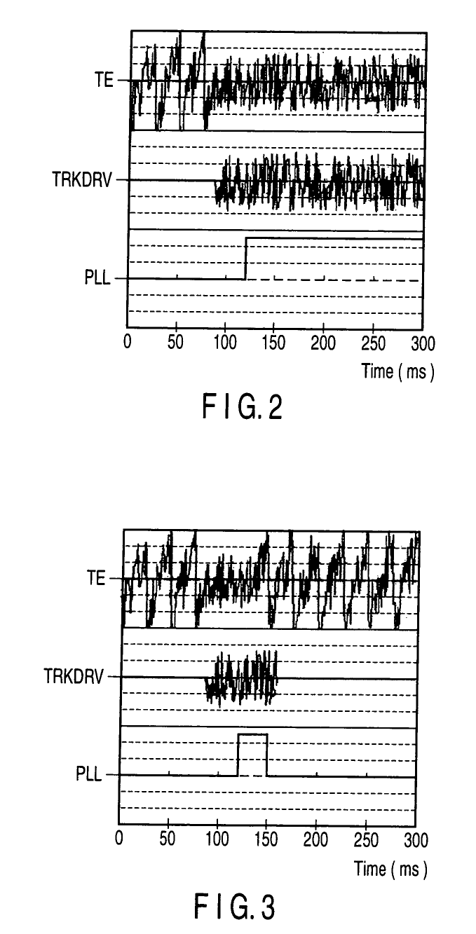

In the control operation, when a residual component of the tracking error signal TE falls within a predetermined allowable range as illustrated in FIG. 2, the CPU 31 monitors the PLL circuit 16 to verify the phase lock state. The CPU 31 determines that track catch has succeeded when the phase lock state is verified, and promptly performs issuing of other commands and access operations. Once the tracking servo signal TRKDRV is turned on, the tracking servo signal TRKDRV is not turned off even when the residual component of the tracking error signal TE exceeds the predetermined allowable range, as long as it is verified that the PLL circuit 16 is in the phase lock state by monitoring the PLL circuit 16.

In comparison with this, when it is determined that the PLL circuit 16 is not in the phase lock state any more, it is determined that track catch has failed, and the tracking servo signal TRKDRV is temporarily turned off. In this case, a track catch attempt operation is performed again with parameters changed. The valid state of the tracking servo is not the same as the phase lock state of the PLL circuit 16. Specifically, the PLL circuit 16 is not always in the phase lock state, even when the tracking servo is in the valid state. However, the PLL circuit 16 is not in the phase lock state, unless the tracking servo is in the valid state. This mechanism enables stable determination of success and failure of track catch.

Further, data reading (reproduction) is not always possible, even when the PLL circuit 16 is in the phase lock state. However, data reading is impossible unless the PLL circuit 16 is in the phase lock state. Since there is such a relationship between them, it is possible to ascertain the state of track catch with reliability. Therefore, it is possible to prevent turning off the tracking servo signal TRKDRV, even though track catch has succeeded. Thus, it is possible to resolve delays in issuance of commands and access operations which are caused by performing track catch attempt operations.

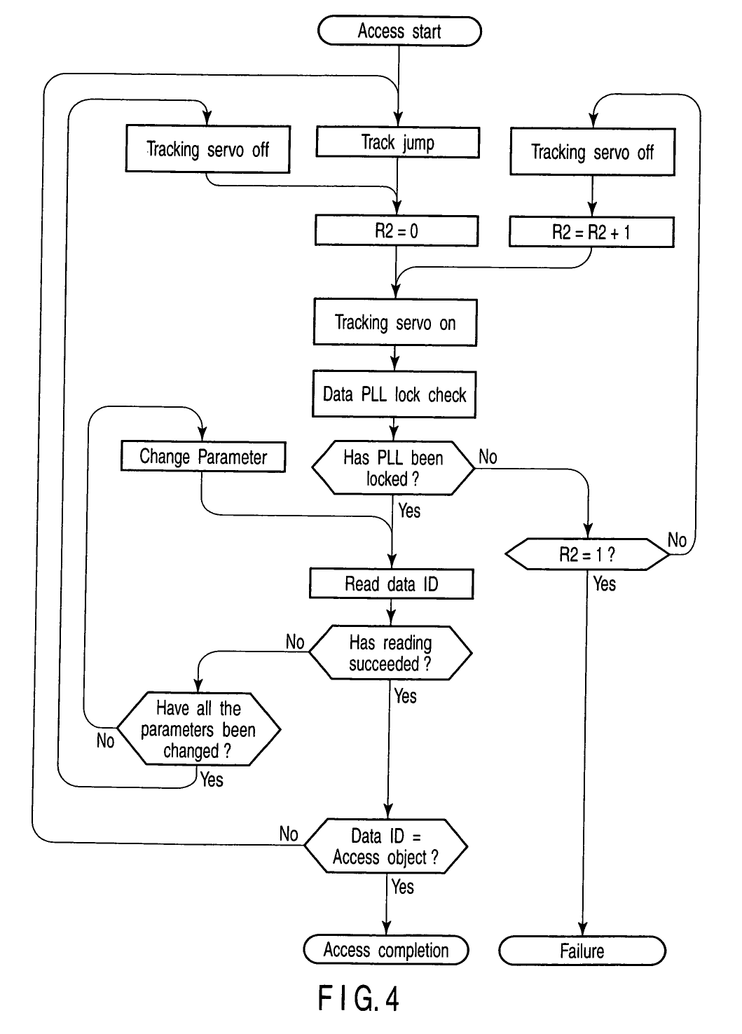

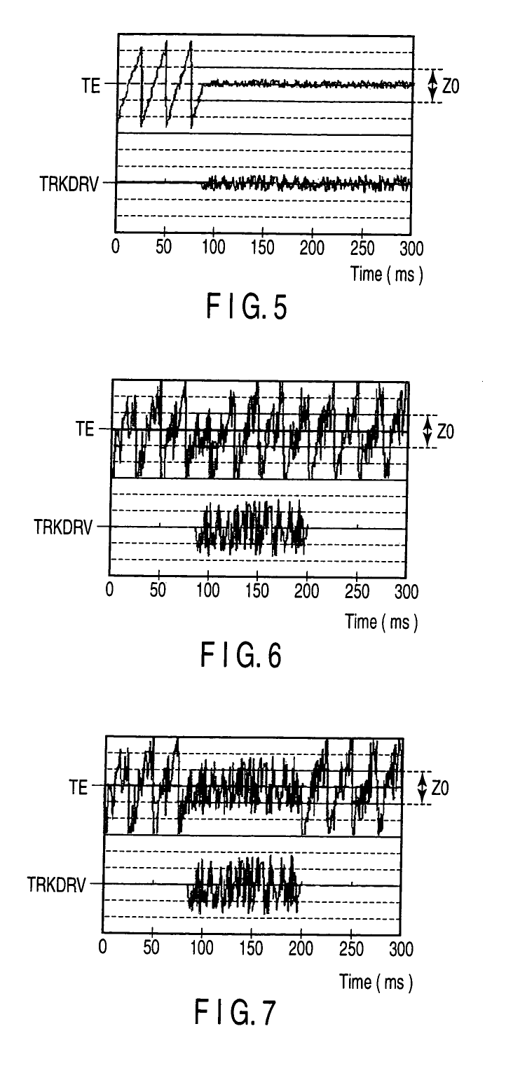

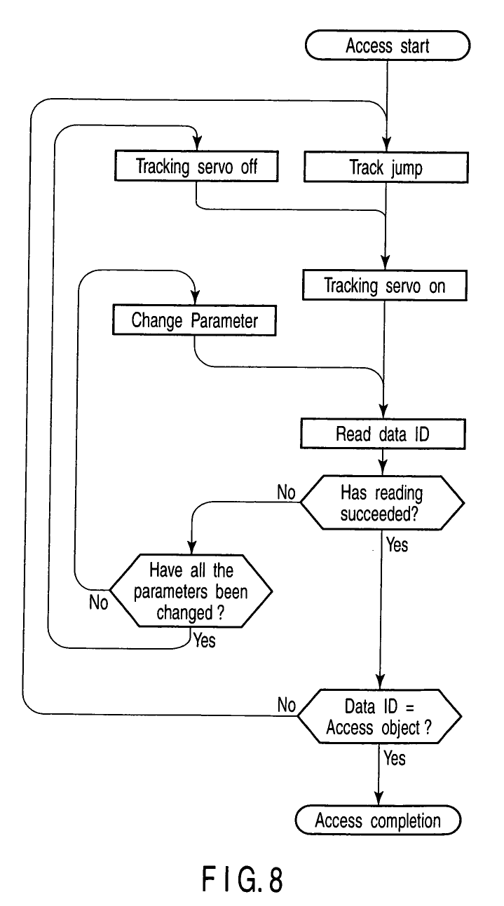

When track catch has failed, the CPU 31 performs processing steps along arrows as illustrated in FIG. 4. Track catch attempts are not performed as frequently as in the prior art in total, and thus it is possible to reduce the load on the track actuator of the pickup 5 and prevent wastage of electric current.

According to the embodiment, the track catch state is determined on the basis of the phase lock state of the PLL circuit 16 for data, and thereby it is possible to perform stable determination, without dependence on the quality of the tracking error signal TE. In addition, by adopting this mechanism, it is possible to prevent a heavy load on the tracking actuator and wastage of electric current, and prevent malfunction of the tracking servo. This contributes to speedup of operation of optical disc apparatuses, such as data reading, command issues, and access operation after success in track catch.

The present invention is not limited to the above embodiment, and can be variously modified within a range not departing from the gist of the invention. For example, although the waveform diagrams used in the explanation of the embodiment illustrate DPD waveforms as the waveform of the tracking error signal TE, the present invention is also applicable to tracking error signals used for recording media such as DPP, CPP, and MPP, and it is possible to prevent malfunction of the tracking servo, and resolve delays in command issues and access operations.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An optical disc apparatus comprising:
a pickup which receives reflected light from an optical disc;
a tracking error detecting section which detects a tracking error from an output signal of the pickup;
a reproducing section which reproduces data in a phase lock state of a data phase, the data lock state being detected by a phase lock loop based on the output signal of the pickup; and
a control section which renders a tracking servo of the pickup for the optical disc valid when a residual component of an error detection signal from the tracking error detecting section in a tracking servo-on state falls within a predetermined allowable range, and renders the tracking servo of the pickup invalid with release of the phase lock state.

2. An optical disc apparatus according to claim 1, wherein the control section is configured to make an attempt to reproduce the data by changing parameters when data reproduction fails in the phase lock state.

3. An optical disc apparatus according to claim 2, wherein the control section is configured to render the tracking servo of the pickup invalid after reproduction of the data is attempted for all the parameters.

4. A tracking control method comprising: receiving reflected light from an optical disc by a pickup; detecting a tracking error as a tracking error signal from an output signal of the pickup; and reproducing data in a phase lock state of a data phase, the data lock state being detected by a phase lock loop based on the output signal of the pickup,
wherein a tracking servo of the pickup for the optical disc is rendered valid when a residual component of the tracking error signal in a tracking servo-on state falls within a predetermined allowable range, and the tracking servo of the pickup is rendered invalid with release of the phase lock state.

5. A tracking control method according to claim 4, wherein reproduction of the data is attempted by changing parameters when reproduction of the data fails in the phase lock state.

6. A tracking control method according to claim 5, wherein the tracking servo of the pickup is rendered invalid after the reproduction of the data is attempted for all the parameters.
